(19) United States
(12) Patent Application Publication
(10) Pub. No.: US 2023/0227614 A1
(43) Pub. Date: Jul. 20, 2023

(54) Polyphosphonate Resin Composition and Molded Product Manufactured Therefrom

(71) Applicant: LOTTE CHEMICAL CORPORATION, Seoul (KR)

(72) Inventors: Jung Jae LEE, Uiwang-si (KR); Jin Yong BAE, Uiwang-si (KR); Hyuck Man KWON, Uiwang-si (KR); Jun Ho CHI, Uiwang-si (KR)

(21) Appl. No.: 18/010,048

(22) PCT Filed: Jun. 29, 2021
(86) PCT No.: PCT/KR2021/008214

§ 371 Date: Dec. 13, 2022

(30) Foreign Application Priority Data
Jun. 30, 2020 (KR) 10-2020-0079775

(51) Int. Cl. C08G 79/04; C08K 5/42; C08L 85/02

(52) U.S. Cl. CPC C08G 79/04; C08K 5/42; C08L 85/02; C08L 2201/02; C08L 2201/08; C08L 2201/10

(57) ABSTRACT

A polyphosphonate resin composition of the present invention comprises: approximately 100 parts by weight of a polyphosphonate resin comprising a repeating unit represented by chemical formula 1; and approximately 0.01-0.05 parts by weight of a sulfonate compound represented by chemical formula 2. The polyphosphonate resin composition has excellent thermal discoloration resistance, light discoloration resistance, flame retardancy, light transmittance and the like.

### TECHNICAL FIELD

The present invention relates to a polyphosphonate resin composition and a molded article manufactured therefrom. More particularly, the present invention relates to a polyphosphonate resin composition that exhibits good properties in terms of heat discoloration resistance, light discoloration resistance, flame retardancy, light transmittance, and the like, and a molded article manufactured therefrom.

### BACKGROUND ART

Generally, a flame retardant is added to and blended with a thermoplastic resin to improve flame retardancy of the thermoplastic resin. Among flame retardants, since use of halogen flame retardants is limited due to environmental problems and the like, despite excellent flame retardancy, phosphorus flame retardants are mainly used in the art. Although phosphate, phosphine oxide, phosphite, and phosphonate can be used as the phosphorus flame retardants, low-molecular weight phosphorus compounds are generally used, thereby causing loss of the phosphorus flame retardants or deterioration in appearance of products formed thereof through volatilization upon processing of the thermoplastic resin at high temperature.

In order to solve such problems of the mixture of the thermoplastic resin and the phosphorus flame retardant, a high molecular weight phosphorus polymer (polyphosphonate resin and the like) can be used as a base resin. However, the high molecular weight phosphorus polymer causes reduction in molecular weight and discoloration under high temperature and/or high humidity conditions.

Therefore, there is a need for a polyphosphonate resin composition having good properties in terms of heat discoloration resistance, light discoloration resistance, flame retardancy, light transmittance, and balance therebetween.

The background technique of the present invention is disclosed in Korean Patent Laid-open Publication No. 10-2017-0091116 and the like.

### DISCLOSURE

### Technical Problem

It is one aspect of the present invention to provide a polyphosphonate resin composition that exhibits good properties in terms of heat discoloration resistance, light discoloration resistance, flame retardancy, light transmittance, and the like.

It is another aspect of the present invention to provide a molded article produced from the polyphosphonate resin composition.

The above and other aspects of the present invention can be achieved by the present invention described below.

### Technical Solution

1. One aspect of the present invention relates to a polyphosphonate resin composition. The polyphosphonate resin composition includes: about 100 parts by weight of a polyphosphonate resin including a repeat unit represented by Formula 1; and about 0.01 to about 0.05 parts by weight of a sulfonate compound represented by Formula 2.

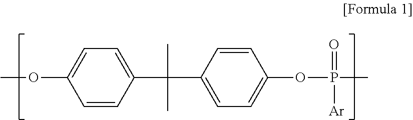

In Formula 1, Ar is a substituted or unsubstituted C₆ to C₂₀ aryl group.

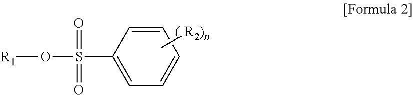

In Formula 2, R₁ is a C₄ to C₁₅ alkyl group, R₂ is a C₁ to C₁₀ alkyl group, and n is an integer of 0 to 5.

2. In embodiment 1, the polyphosphonate resin may include a polymer of bisphenol-A and diarylaryl phosphonate.

3. In embodiment 1 or 2, the polyphosphonate resin may include about 90 mol % or more of the repeat unit represented by Formula 1 based on 100 mol % of all repeat units.

4. In embodiments 1 to 3, the polyphosphonate resin may have a weight average molecular weight (Mw) of about 20,000 to about 100,000 g/mol, as measured by gel permeation chromatography (GPC).

5. In embodiments 1 to 4, the polyphosphonate resin composition may have a yellowness index difference (ΔYI) of about 5 or less, as calculated by Equation 1:

Yellowness index difference (ΔYI)=YI₁−YI₀ [Equation 1]

where YI₀ is an initial yellowness index (YI) of a 2.5 mm thick specimen of the resin composition, as measured in accordance with ASTM D1925, and YI₁ is a yellowness index (YI) of the specimen, as measured in accordance with ASTM D1925 after the specimen is left at 200° C. for 5 minutes.

6. In embodiments 1 to 5, the polyphosphonate resin composition may have a yellowness index difference (ΔYI) of about 7 or less, as calculated by Equation 2:

Yellowness index difference (ΔYI)=YI₂−YI₀ [Equation 2]

where YI₀ is an initial yellowness index (YI) of a 2.5 mm thick specimen of the resin composition, as measured in accordance with ASTM D1925, and YI₂ is a yellowness index (YI) of the specimen, as measured in accordance with ASTM D1925 after the specimen is irradiated with UV light at 60° C. under conditions of a wavelength of 313 nm and a current density of 0.63 W/m² for 12 hours.

7. In embodiments 1 to 6, the polyphosphonate resin composition may have a flame retardancy of V-0 or higher, as measured on a 0.7 mm thick specimen in accordance with a UL-94 vertical test method.

8. In embodiments 1 to 7, the polyphosphonate resin composition may have a light transmittance of about 87% or more, as measured on a 2.5 mm thick specimen in accordance with ASTM D1003.

9. Another aspect of the present invention relates to a molded article. The molded article is manufactured from the polyphosphonate resin composition according to any one of embodiments 1 to 8.

### Advantageous Effects

The present invention provides a polyphosphonate resin composition that has good properties in terms of heat discoloration resistance, light discoloration resistance, flame retardancy, light transmittance, and the like, and a molded article manufactured therefrom.

### BEST MODE

Hereinafter, embodiments of the present invention will be described in detail.

A polyphosphonate resin composition according to the present invention includes: (A) a polyphosphonate resin; and (B) a sulfonate compound.

As used herein to represent a specific numerical range, the expression “a to b” means “≥a and ≤b”.

(A) Polyphosphonate Resin

According to the present invention, the polyphosphonate resin is used as a base resin to improve heat discoloration resistance, light discoloration resistance, flame retardancy, light transmittance, and the like of the resin composition together with a specific sulfonate compound. The polyphosphonate resin includes a repeat unit represented by Formula 1.

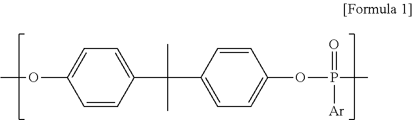

where Ar is a substituted or unsubstituted C₆ to C₂₀ aryl group.

In some embodiments, the polyphosphonate resin may be prepared by reacting an aromatic diol compound, such as bisphenol-A and the like, with a diarylaryl phosphonate. Reaction may be carried out by a polyphosphonate polymerization method known in the art.

In some embodiments, the aromatic diol compound may include bisphenol-A(2,2-bis(4-hydroxyphenyl)propane), 4,4′-biphenol, 2,4-bis(4-hydroxyphenyl) methylbutane, 1,1-bis(4-hydroxyphenyl)cyclohexane, 2,2-bis(3-chloro-4-hydroxyphenyl)propane, 2,2-bi s(3,5-dichloro-4-hydroxyphenyl)propane, 2,2-bis(3-methyl-4-hydroxyphenyl)propane, 2,2-bis(3,5-dimethyl-4-hydroxyphenyl)propane, and the like. For example, the aromatic diol compound may be 2,2-bis(4-hydroxyphenyl)propane, 2,2-bi s(3,5-dichloro-4-hydroxyphenyl)propane, 2,2-bis(3-methyl-4-hydroxyphenyl)propane, or 1,1-bi s(4-hydroxyphenyl)cycl ° hexane. Specifically, the aromatic diol compound may be 2,2-bis(4-hydroxyphenyl)propane, which is also referred to as bisphenol-A.

In some embodiments, the diarylaryl phosphonate may include diphenyl phenyl phosphonate, diphenyl tolyl phosphonate, diphenyl naphthyl phosphonate, and the like.

In some embodiments, the polyphosphonate resin may include about 90 mol % or more, for example, about 95 to about 100 mol %, of the repeat unit represented by Formula 1, based on 100 mol % of all repeat units. In other words, the polyphosphonate resin may be prepared by reacting about 90 mol % or more, for example, about 95 to about 100 mol %, of bisphenol-A and the balance of at least one of other aromatic diol compounds, as the aromatic diol compounds, with the diarylaryl phosphonate. Within this range, the polyphosphonate resin can be used as the base resin and can improve heat discoloration resistance, light discoloration resistance, and the like of the resin composition.

In some embodiments, the polyphosphonate resin may have a weight average molecular weight (Mw) of about 20,000 to about 100,000 g/mol, for example, about 20,000 to about 50,000 g/mol, as measured by gel permeation chromatography (GPC). Within this range, the polyphosphonate resin can be used as the base resin and can improve heat discoloration resistance, light discoloration resistance, and the like of the resin composition.

(B) Sulfonate Compound

According to the present invention, the sulfonate compound serves to improve heat discoloration resistance, light discoloration resistance, and the like of the polyphosphonate resin composition and includes a compound represented by Formula 2.

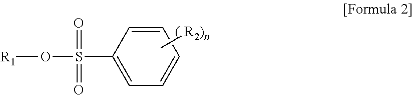

where R₁ is a C₄ to C₁₅ alkyl group, R₂ is a C₁ to C₁₀ alkyl group, and n is an integer of 0 to 5.

In some embodiments, the sulfonate compound may include butyl p-toluene sulfonate, pentyl p-toluene sulfonate, hexyl p-toluene sulfonate, heptyl p-toluene sulfonate, octyl p-toluene sulfonate, nonyl p-toluene sulfonate, decyl p-toluene sulfonate, dodecyl p-toluene sulfonate, and combinations thereof.

In some embodiments, the sulfonate compound may be present in an amount of about 0.01 to about 0.05 parts by weight, for example, about 0.02 to about 0.04 parts by weight, relative to about 100 parts by weight of the polyphosphonate resin. If the content of the sulfonate compound is less than about 0.01 parts by weight relative to about 100 parts by weight of the polyphosphonate resin, the polyphosphonate resin composition can suffer from deterioration in heat discoloration resistance, light discoloration resistance, and the like, and if the content of the sulfonate compound exceeds about 0.05 parts by weight, the polyphosphonate resin composition can suffer from deterioration in heat discoloration resistance and the like.

According to one embodiment of the invention, the polyphosphonate resin composition may further include additives used in typical thermoplastic resin composition. The additives may include, for example, impact modifiers, inorganic fillers, antioxidants, anti-dripping agents, lubricants, release agents, nucleating agents, antistatic agents, stabilizers, pigments, dyes, and mixtures thereof, without being limited thereto. The additives may be present in an amount of about 0.001 to about 40 parts by weight, for example, about 0.01 to about 10 parts by weight, relative to about 100 parts by weight of the polyphosphonate resin.

According to one embodiment of the invention, the polyphosphonate resin composition may be blended with a typical thermoplastic resin to improve heat resistance, heat discoloration resistance and flame retardancy of the thermoplastic resin. The thermoplastic resin may include, for example, a polycarbonate resin, a polyester resin, a polyamide resin, and a rubber-modified aromatic vinyl copolymer resin, without being limited thereto.

The polyphosphonate resin composition according to one embodiment of the invention may be prepared in pellet form by mixing the above components, followed by melt extrusion of the mixture using a typical twin-screw extruder at about 140 to about 220° C., for example, about 150 to about 200° C.

In some embodiments, the polyphosphonate resin composition may have a yellowness index difference (ΔYI) of about 5 or less, for example, about 1 to about 4, as calculated by Equation 1.

Yellowness index difference (ΔYI)=YI₁−YI₀ [Equation 1]

where YI₀ is an initial yellowness index (YI) of a 2.5 mm specimen of the resin composition, as measured in accordance with ASTM D1925, and YI₁ is a yellowness index (YI) of the specimen, as measured in accordance with ASTM D1925 after the specimen is left at 200° C. for 5 minutes.

In some embodiments, the polyphosphonate resin composition may have a yellowness index difference (ΔYI) of about 7 or less, for example, about 1 to about 6, as calculated by Equation 2.

Yellowness index difference (ΔYI)=YI₂−YI₀ [Equation 2]

where YI₀ is an initial yellowness index (YI) of a 2.5 mm thick specimen of the resin composition, as measured in accordance with ASTM D1925, and YI₂ is a yellowness index (YI) of the specimen, as measured in accordance with ASTM D1925 after the specimen is irradiated with UV light at 60° C. under conditions of a wavelength of 313 nm and a current density of 0.63 W/m² for 12 hours.

In some embodiments, the polyphosphonate resin composition may have a flame retardancy of V-0 or higher, as measured on a 0.7 mm thick specimen in accordance with a UL-94 vertical test method.

In some embodiments, the polyphosphonate resin composition may have a light transmittance of about 87% or more, for example, about 88% or more, as measured on a 2.5 mm thick specimen in accordance with ASTM D1003.

A molded article according to the present invention is produced from the polyphosphonate resin composition set forth above. The polyphosphonate resin composition may be prepared in pellet form. The prepared pellets may be produced into various molded articles (products) by various molding methods, such as injection molding, extrusion, vacuum molding, and casting. These molding methods are well known to those skilled in the art. The molded articles according to the present invention have good properties in terms of heat discoloration resistance, light discoloration resistance, flame retardancy, light transmittance, and balance therebetween, and are useful as interior/exterior materials of electric/electronic products.

### MODE FOR INVENTION

Next, the present invention will be described in more detail with reference to some examples. It should be understood that these examples are provided for illustration only and are not to be construed in any way as limiting the invention.

### EXAMPLE

Details of components used in Examples and Comparative Examples are as follows.

(A) Base resin

(A1) A bisphenol-A polyphosphonate resin prepared through reaction of bisphenol-A and diphenyl phenyl phosphonate and having a weight average molecular weight of 25,200 g/mol was used.

(A2) A bisphenol-A polyphosphonate resin prepared through reaction of bisphenol-A and diphenyl phenyl phosphonate and having a weight average molecular weight of 11,600 g/mol was used.

(A3) A bisphenol-A polyphosphonate resin prepared through reaction of bisphenol-A and diphenyl phenyl phosphonate and having a weight average molecular weight of 17,000 g/mol was used.

(A4) A bisphenol-A polycarbonate resin having a weight average molecular weight (Mw) of 25,000 g/mol was used.

(B) Sulfonate Compound

(B1) Butyl p-toluene sulfonate (Manufacturer: TCI Chemicals) was used.

(B2) Dodecyl p-toluene sulfonate (Manufacturer: Hangzhou Keying Chem.) was used.

(C) Ethyl p-toluene sulfonate (Manufacturer: Sigma Aldrich) was used.

(D) Bisphenol-A diphosphate (Manufacturer: Daihachi, Product Name: DVP506) was used.

### Examples 1 to 6 and Comparative Examples 1 to 7

The above components were mixed in amounts as listed in Tables 1 and 2 and subjected to extrusion under conditions of 160° C., thereby preparing pellets. Extrusion was performed using a twin-screw extruder (L/D=36, Φ45 mm) and the prepared pellets were dried at 80° C. for 4 hours or more and injection-molded in a 6 oz. injection molding machine (molding temperature: 200° C., mold temperature: 70° C.), thereby preparing specimens. The specimens were evaluated as to properties by the following method and results are shown in Tables 1 and 2.

### Comparative Example 8

The above components were mixed in amounts as listed in Table 2 and subjected to extrusion under conditions of 270° C., thereby preparing pellets. Extrusion was performed using a twin-screw extruder (L/D=36, Φ45 mm) and the prepared pellets were dried at 120° C. for 4 hours or more and injection-molded in a 6 oz. injection molding machine (molding temperature: 290° C., mold temperature: 70° C.), thereby preparing specimens. The specimens were evaluated as to properties by the following method and results are shown in Table 2.

Property Measurement

(1) Heat discoloration resistance: Yellowness index difference (ΔYI) was calculated according to Equation 1.

Yellowness index difference (ΔYI)=YI₁−YI₀ [Equation 1]

where YI₀ is an initial yellowness index (YI) of a 2.5 mm thick specimen of the resin composition, as measured in accordance with ASTM D1925, and YI₁ is a yellowness index (YI) of the specimen, as measured in accordance with ASTM D1925 after the specimen is left at 200° C. for 5 minutes.

(2) Light discoloration resistance: Yellowness index difference (ΔYI) was calculated according to Equation 2.

Yellowness index difference (ΔYI)=YI₂−YI₀ [Equation 2]

where YI₀ is an initial yellowness index (YI) of a 2.5 mm thick specimen of the resin composition, as measured in accordance with ASTM D1925, and Y12 is a yellowness index (YI) of the specimen, as measured in accordance with ASTM D1925 after the specimen is irradiated with UV light at 60° C. under conditions of a wavelength of 313 nm and a current density of 0.63 W/m² for 12 hours.

(3) Flame retardancy: Flame retardancy was measured on a 0.7 mm thick specimen in accordance with UL-94.

(4) Light transmittance: Light transmittance was measured on a 2.5 mm thick specimen using a haze meter (NDH 2000, Nippon Denshoku) in accordance with ASTM D1003.

TABLE 1

| | Example | | | | | |
|---|---|---|---|---|---|---|
| | 1 | 2 | 3 | 4 | 5 | 6 |
| (A1) (parts by weight) | 100 | 100 | 100 | 100 | 100 | 100 |
| (A2) (parts by weight) | — | — | — | — | — | — |
| (A3) (parts by weight) | — | — | — | — | — | — |
| (A4) (parts by weight) | — | — | — | — | — | — |
| (B1) (parts by weight) | 0.02 | 0.03 | 0.04 | — | — | — |
| (B2) (parts by weight) | — | — | — | 0.02 | 0.03 | 0.04 |
| (C) (parts by weight) | — | — | — | — | — | — |
| Heat discoloration | 3.6 | 2.9 | 2.6 | 3.0 | 2.3 | 2.2 |
| resistance (ΔYI) | | | | | | |
| Light discoloration | 5.7 | 4.5 | 4.3 | 5.5 | 4.5 | 4.3 |
| resistance (ΔYI) | | | | | | |
| Flame retardancy | V-0 | V-0 | V-0 | V-0 | V-0 | V-0 |
| Light transmittance (%) | 88.1 | 88.3 | 88.4 | 88.2 | 88.3 | 88.5 |

TABLE 2

| | Comparative Example | | | | | | | |
|---|---|---|---|---|---|---|---|---|
| | 1 | 2 | 3 | 4 | 5 | 6 | 7 | 8 |
| (A1) (parts by weight) | — | — | 100 | 100 | 100 | 100 | 100 | — |
| (A2) (parts by weight) | 100 | — | — | — | — | — | — | — |
| (A3) (parts by weight) | — | 100 | — | — | — | — | — | — |
| (A4) (parts by weight) | — | — | — | — | — | — | — | 100 |
| (B1) (parts by weight) | 0.03 | 0.03 | 0.005 | 0.07 | — | — | — | — |
| (B2) (parts by weight) | — | — | — | — | 0.005 | 0.07 | — | — |
| (C) (parts by weight) | — | — | — | — | — | — | 0.03 | — |
| (D) (parts by weight) | — | — | — | — | — | — | — | 17.6 |
| Heat discoloration | 8.9 | 8.3 | 8.5 | 7.4 | 8.3 | 7.5 | 13.3 | — |
| resistance (ΔYI) | | | | | | | | |
| Light discoloration | 8.3 | 7.9 | 8.0 | 6.1 | 8.1 | 6.3 | 9.7 | 4.7 |
| resistance (ΔYI) | | | | | | | | |
| Flame retardancy | V-0 | V-0 | V-0 | V-0 | V-0 | V-0 | V-0 | V-2 |
| Light transmittance | 82.9 | 84.3 | 87.8 | 87.6 | 87.6 | 87.5 | 87.4 | 90.7 |

From the result, it could be seen that the polyphosphonate resin compositions according to the present invention exhibited good properties in terms of heat discoloration resistance, light discoloration resistance, flame retardancy, light transmittance, and balance therebetween.

Conversely, it could be seen that the polyphosphonate resin compositions of Comparative Examples 1 and 2 prepared using the polyphosphonate resins (A2) and (A3) instead of the polyphosphonate resin of the present invention suffered from deterioration in heat discoloration resistance, light discoloration resistance, light transmittance, and the like. It could be seen that the polyphosphonate resin composition prepared using an insufficient amount of the sulfonate compound (B1) (Comparative Example 3) suffered from deterioration in heat discoloration resistance, and light discoloration resistance; the polyphosphonate resin composition prepared using an excess of the sulfonate compound (B1) (Comparative Example 4) suffered from deterioration in heat discoloration resistance; the polyphosphonate resin composition prepared using an insufficient amount of the sulfonate compound (B2) (Comparative Example 5) suffered from deterioration in heat discoloration resistance and light discoloration resistance; and the polyphosphonate resin composition prepared using an excess of the sulfonate compound (B2) (Comparative Example 6) suffered from deterioration in heat discoloration resistance and the like. Further, it could be seen that the polyphosphonate resin composition prepared using ethyl p-toluene sulfonate (C) (Comparative Example 7) instead of the sulfonate compound of the present invention suffered from deterioration in heat discoloration resistance, light discoloration resistance, and the like; and the resin composition (Comparative Example 8) prepared using the polycarbonate resin instead of the polyphosphonate resin as the base resin and a typical phosphorus flame retardant (D) suffered from significant deterioration in flame retardancy and the like, despite including a higher amount of the flame retardant than the base resin.

Although some exemplary embodiments have been described herein, it should be understood by those skilled in the art that these embodiments are given by way of illustration only, and that various modifications, variations and alterations can be made without departing from the spirit and scope of the invention. Therefore, the embodiments should not be construed as limiting the scope of the invention, but should be construed as illustrating the invention. The scope of the present invention should be interpreted according to the following appended claims as covering all modifications or variations derived from the appended claims and equivalents thereto.

1. A polyphosphonate resin composition comprising:
about 100 parts by weight of a polyphosphonate resin comprising a repeat unit represented by Formula 1; and
about 0.01 to about 0.05 parts by weight of a sulfonate compound represented by Formula 2: 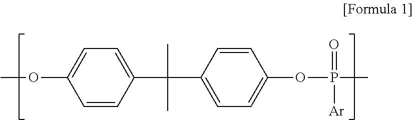
where Ar is a substituted or unsubstituted C₆ to C₂₀ aryl group; 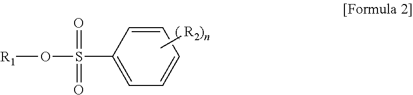
where R₁ is a C₄ to C₁₅ alkyl group, R₂ is a C₁ to C₁₀ alkyl group, and n is an integer of 0 to 5.

2. The polyphosphonate resin composition according to claim 1, wherein the polyphosphonate resin comprises a polymer of bisphenol-A and diarylaryl phosphonate.

3. The polyphosphonate resin composition according to claim 1, wherein the polyphosphonate resin comprises about 90 mol % or more of the repeat unit represented by Formula 1 based on 100 mol % of all repeat units.

4. The polyphosphonate resin composition according to claim 1, wherein the polyphosphonate resin has a weight average molecular weight (Mw) of about 20,000 to about 100,000 g/mol, as measured by gel permeation chromatography (GPC).

5. The polyphosphonate resin composition according to claim 1, wherein the polyphosphonate resin composition has a yellowness index difference (ΔYI) of about 5 or less, as calculated by Equation 1:
Yellowness index difference (ΔYI)=YI₁−YI₀ [Equation 1]
where YI₀ is an initial yellowness index (YI) of a 2.5 mm thick specimen of the resin composition, as measured in accordance with ASTM D1925, and YI₁ is a yellowness index (YI) of the specimen, as measured in accordance with ASTM D1925 after the specimen is left at 200° C. for 5 minutes.

6. The polyphosphonate resin composition according to claim 1, wherein the polyphosphonate resin composition has a yellowness index difference (ΔYI) of about 7 or less, as calculated by Equation 2:
Yellowness index difference (ΔYI)=YI₂−YI₀ [Equation 2]
where YI₀ is an initial yellowness index (YI) of a 2.5 mm thick specimen of the resin composition, as measured in accordance with ASTM D1925, and YI₂ is a yellowness index (YI) of the specimen, as measured in accordance with ASTM D1925 after the specimen is irradiated with UV light at 60° C. under conditions of a wavelength of 313 nm and a current density of 0.63 W/m² for 12 hours.

7. The polyphosphonate resin composition according to claim 1, wherein the polyphosphonate resin composition has a flame retardancy of V-0 or higher, as measured on a 0.7 mm thick specimen in accordance with a UL-94 vertical test method.

8. The polyphosphonate resin composition according to claim 1, wherein the polyphosphonate resin composition has a light transmittance of about 87% or more, as measured on a 2.5 mm thick specimen in accordance with ASTM D1003.

9. A molded article manufactured from the polyphosphonate resin composition according to claim 1.
